(19) United States
(12) Patent Application Publication
(10) Pub. No.: US 2010/0125697 A1
(43) Pub. Date: May 20, 2010

(54) COMPUTING DEVICE HAVING STORAGE, APPARATUS AND METHOD OF MANAGING STORAGE, AND FILE SYSTEM RECORDED RECORDING MEDIUM

(76) Inventors: Chul LEE, Suwon-si (KR); Seung-woo RYU, Seoul (KR); Jung-hwan KIM, Seoul (KR); Sung-jong SEO, Suwon-si (KR)

Correspondence Address: North Star Intellectual Property Law, PC, P.O. Box 34688, Washington, DC, 20043, US

(21) Appl. No.: 12/547,667

(22) Filed: Aug. 26, 2009

(30) Foreign Application Priority Data
Nov. 14, 2008 (KR) 10-2008-0113318

(51) Int. Cl. G06F 12/02; G06F 12/00

(52) U.S. Cl. 711/103; 711/170; 711/E12.002; 707/E17.01; 711/E12.001; 711/E12.008

(57) ABSTRACT

A storage management apparatus and a file system for a storage device are provided. The storage management apparatus allocates a portion of storage for writing a file to the storage, including a table storing unit storing an allocation unit table that includes information of a unit of allocation of the storage according to a file extension of a file to be written. A storage management unit manages the storage based on the allocation unit table.

### CROSS REFERENCE TO RELATED APPLICATION

This application claims the benefit under 35 U.S.C. §119(a) of Korean Patent Application No. 10-2008-113318, filed on Nov. 14, 2008 in the Korean Intellectual Property Office, the disclosure of which is incorporated herein in its entirety by reference for all purposes.

### BACKGROUND

1. Field

The following description relates to a storage management technology and a file system for a physical storage device.

2. Description of the Related Art

Generally, since NAND flash operates with different units for erasing and writing data, i.e. a block (128 KB) for erasing and a page (2 KB) for writing, the performance of NAND flash may deteriorate if several NAND blocks are allocated to a single file when data is read out from and written to the file. For example, when pieces of data are located in a number of different blocks, reading speed may be degraded due to fragmentation of the data. Accordingly, research has been conducted for designating a file system that avoids data fragmentation.

File fragmentation occurs when a user of a file system runs an application without considering the operation and structure of the NAND flash. File fragmentation might be reduced if a system developer or an application developer programs applications in consideration of all characteristics of the NAND flash or the size of a file. However, it is not practically possible for the file system developer to take into account every circumstance that might occur. Thus, since various applications may handle a file system differently, it is difficult to estimate in advance the required size of a block for writing a file, resulting in the fragmentation.

In addition, when there is information or data to be appended to the file, additional space is allocated for the appended information or data, resulting in the fragmentation. In related arts, several allocation schemes are taught, including a simple allocation scheme in which free clusters are sequentially allocated, and an anti-fragmentation cluster allocation scheme in which the size of space to be allocated increases with the size of a file. Moreover, a pre-allocation scheme reserves space in units of blocks for a file, and a delayed allocation scheme has a plurality of page caches for finding an optimal size of space for a file.

### SUMMARY

In one general aspect, a storage management apparatus includes a table storing unit for storing an allocation unit table and a storage management unit for managing the storing of a file in a storage device, according to the allocation unit table, wherein the allocation unit table includes information of a unit of allocation for storing the file in the storage device, according to a file extension of the file.

The unit of allocation may be selected as at least one from a group consisting of a block, a page, and a track.

When the storage device includes a NAND flash, the unit of allocation may be selected as one of a page or a block.

When the storage device includes a hard disk drive (HDD), the unit of allocation may be selected as a track.

When the unit of allocation is selected as a block, the storage management unit may write the file in an allocated block substantially continuously.

The storage management apparatus may further include an update unit for updating the allocation unit table according to a size of a written file.

The update unit may update the allocation unit table using according to an average of the actual size of the written file.

The update unit may compare the actual size of the written file to a predetermined threshold and updates the allocation unit table.

In another general aspect, a storage management apparatus includes a storing unit including at least two storage devices, a table storing unit for storing an allocation unit table, and a storage management unit for managing the storing of the file in each of the storage devices, according to the allocation unit table, wherein the allocation unit table includes information of a unit of allocation for storing the file in each of the storage devices, according to a file extension of the file.

Each of the storage devices may be one selected from the group consisting of a NAND flash, a hard disk, and a phase-change random access memory (PRAM).

The unit of allocation may be selected as at least one from a group consisting of a block, a page, and a track.

The storage management apparatus may further include an update unit for updating the allocation unit table according to a size of a written file.

The update unit may update the allocation unit table according to an average of the size of the written file.

The update unit may compare the size of the written file to a predetermined threshold and may also update the allocation unit table.

In another general aspect, a computing device for controlling and managing a storage, includes a storing unit for storing a file, and a storage management unit for allocating a predetermined region of the storing unit for writing a file to the storing unit and for managing the storing unit, wherein the storage management unit selects a unit of allocation for the storing unit according to a file extension of the file When the storing unit includes a NAND flash, the unit of allocation may be selected as one of a page or a block.

When the storing unit includes a hard disk drive (HDD), the unit of allocation may be selected as a track.

When the unit of allocation is selected as a block, the storage management unit may write the file in an allocated block substantially continuously.

In another general aspect, a storage management method includes loading an allocation unit table, and allocating a storage based on the allocation unit table, wherein the allocation unit table includes information of a unit of allocation for storing according to a file extension.

The storage management method may further include updating the allocation unit table according to a size of a file.

In another general aspect, a computer-readable recording medium having embodied thereon a computer program for executing a storage management method includes loading an allocation unit table, and allocating a storage based on the allocation unit table, wherein the allocation unit table includes information of a unit of allocation for storing according to a file extension.

When the storage includes a NAND flash, the unit of alloction may be selected as one of a page or a block.

When the storage includes a hard disk drive (HDD), the unit of allocation may be selected as a track.

Other features will become apparent to those skilled in the art from the following detailed description, the drawings, and the claims.

### BRIEF DESCRIPTION OF THE DRAWINGS

FIG. 1 is a block diagram illustrating an exemplary computing device.

FIG. 2 is a diagram illustrating an exemplary storage management apparatus.

FIG. 3 illustrates an exemplary allocation unit table.

FIG. 4 is a block diagram illustrating an exemplary storage management apparatus.

FIG. 5 illustrates another exemplary allocation unit table.

FIG. 6 is a diagram illustrating an example of storage allocation.

FIG. 7 is a flowchart illustrating an exemplary method of managing storage.

FIG. 8 is a diagram illustrating management of a storage unit.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will be suggested to those of ordinary skill in the art. Descriptions of well-known functions and structures may be omitted for increased clarity and conciseness.

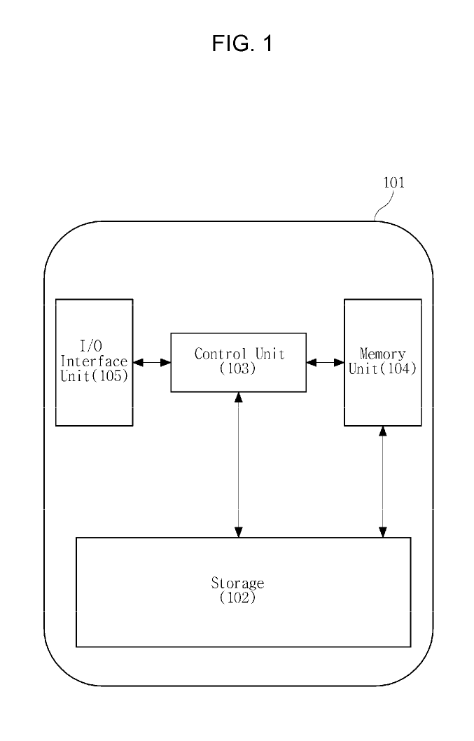

FIG. 1 is a block diagram illustrating an exemplary computing device 101. Referring to FIG. 1, the computing device 101 may be a personal computer (PC), a mobile phone, a digital camera, a personal digital assistant (PDA), a portable multimedia player (PMP), or the like. The computing device 101 may include a storage 102, a control unit 103, a memory unit 104, and an input/output interface unit 105.

The storage 102 may be a physical storage device such as a hard disk (HDD) or NAND flash, and may be included in the interior of the computing device 101 or may be externally connected and/or disconnected to the computing device 101. The control unit 103 may be a central processing unit (CPU), microcomputer, or the like, and control the computing device 101 in accordance with a mounted operating system (OS). The memory unit 104 may be a random access memory (RAM), an electrically erasable and programmable read only memory (EEPROM), or the like. The I/O interface unit 105 may be a touch screen, a keyboard, a mouse, or the like.

The computing device 101 stores various types of data using the storage 102, and provides the stored data to a user. For example, if the computing device 101 is a mobile phone, the control unit 103 may receive information through the input/output (I/O) interface unit 105, and store the received information in the storage 102. Moreover, if the computing device 101 is a digital camera, the control unit 103 may load photos stored in the storage to the memory unit 104, and provide the photos to the user through the input/output interface unit 105.

As such, the computing device 101 includes the storage 102 for storing various types of files, and employs functions for writing the files to the storage 102 and reading or erasing files from the storage 102. Such functions are supported by a storage management apparatus, which may be mounted by the OS of the control unit or may be hard-coded in a file system of the OS.

As one example, the computing device 101 may allocate a predetermined portion of the storage 102 for writing files to the storage 102. Additionally, the computing device 101 may specify the unit of allocation according to a file extension information (e.g., TXT, JPG, or MP3, which is a suffix of a computer file for indicating a file type) of a file to be written in the storage 102, wherein the unit of allocation may affect the performance of the storage 102.

The unit of allocation may affect the performance of the storage 102 may be the unit of operation of the storage 102. For example, if the storage 102 is a NAND flash, the storage 102 performs reading and writing in units of pages, and performs erasing in units of blocks. Thus, in this case, the unit of allocation which affects the performance of the storage 102 may be specified as a page or a block.

For example, if the storage 102 is a NAND flash and a file to be written is a music file, of which the file extension is MP3, when the computing device 101 allocates a predetermined portion of the storage 102 to store the MP3 file in the storage 102, the unit of allocation may be specified as a block, since an mp3 file size is relatively large, and the MP3 file may be written contiguously onto a corresponding block. Generally, once the file is modified, the files previously written on the block are allocated to another block according to an “out-of-place” rule, and thus the previous block is often becomes a “garbage” block. However, as described above, if a file is contiguously written to a corresponding block, less merging occurs, thereby reducing the probability of garbage collection when erasing in units of blocks.

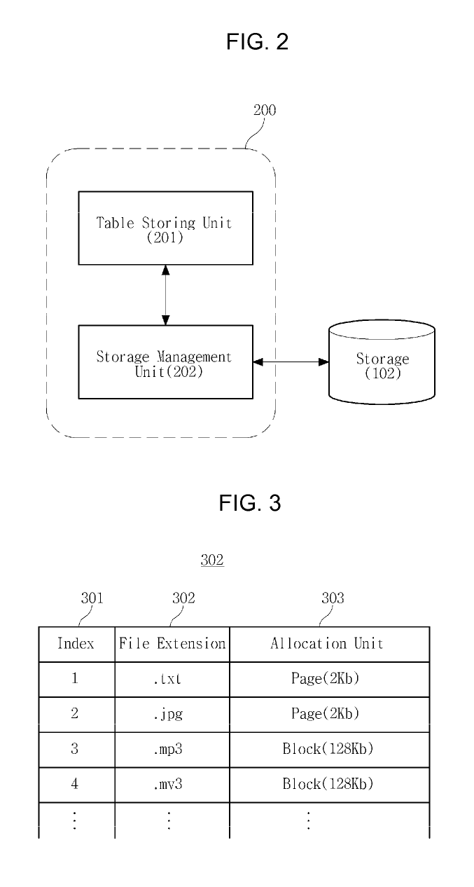

FIG. 2 is a diagram illustrating an exemplary storage management apparatus 200. Referring to FIG. 2, the storage management apparatus 200 includes a table storing unit 201 and a storage management unit 202.

The storage management apparatus 200 may be hard-coded in a file system. The storage management apparatus 200 may be included in the storage 102 (referring to FIG. 1) and selectively loaded, or may be included in the OS of the computing device 101. Moreover, the storage management apparatus 200 may be recorded, stored, or fixed in one or more computer readable recording media.

In FIG. 2, the storage management apparatus 200 allocates a portion of the storage 102 for writing a file. Also, the storage management apparatus 200 may read or erase a file from the storage 102.

The table storing unit 201 stores an allocation unit table that indicates the unit of allocation of the storage 102 according to a file extension of a file to be written. Here, the unit of allocation may be a unit that affects the performance of the storage 102. For example, if the storage 102 is a NAND flash, the unit of allocation that affects the performance of the storage 102 may be a page or an erasable block. As another example, if the storage 102 is a hard disk drive, the unit of allocation that affects the performance may be a track.

The storage management unit 202 may control and manage the storage 102, and also may allocate the storage 102 according to a scheme indicated by the allocation unit table stored in the table storing unit 201. For example, if the storage 102 is a NAND flash and the result of analyzing the file extension of a file to be written indicates that the unit of allocation is a block, the storage management unit 202 may allocate portions of the storage 102 in units of blocks, and write a file contiguously on a corresponding block.

The above-described allocation is executed in consideration of statistical correlation between the file extension and the size of a corresponding file. For example, since files with file extensions of MP3 and AVI are highly likely to be large data of more than about 3 MB, the storage 102 is allocated in units of NAND blocks, and in the case of txt files which are typically only of several KB, the storage 102 is allocated in units of pages in order to improve read/write performance.

FIG. 3 illustrates an exemplary allocation unit table. Referring to FIG. 3, the allocation unit table may include index information 301, file extension information 302, and information of the unit of allocation 303.

The index information 301 facilitates searching, and may include a hash function or a hash key. In FIG. 3, for simplicity, the index information 301 is illustrated as a series of numbers.

The file extension information 302 may be composed of letters such as jpg, txt, and mp3, which are a suffix to a file to indicate a type of the file.

The information of the unit of allocation 303 may indicate the unit of allocation, which alters the performance of the storage 102, and is designated in consideration of the file extension information 302. In FIG. 3, a NAND flash is illustrated as an example, with a unit of allocation as a page or a block. However, if the storage 102 is a hard disk drive, the unit of allocation may be a track (for example, a track number).

Referring to FIG. 3, data indicated by the first row of the table is a txt file, having a relatively small size. Therefore, a page (or 2 KB of a page size) is designated as the unit of allocation. In comparison, data indicated by the third row of the table is a MP3 file, having a relatively large size, and therefore a block (or 128 KB of a block size) is designated as the unit of allocation.

As such, since an approximate size of a file can be estimated based upon the file extension information, the unit of allocation of the file may be set according to the file extension. Furthermore, in setting the unit of allocation, the performance of the storage 102 may be improved by setting the unit of allocation, as performance varies with the unit of allocation.

The allocation unit table may be maintained as initially established, or may be regularly updated.

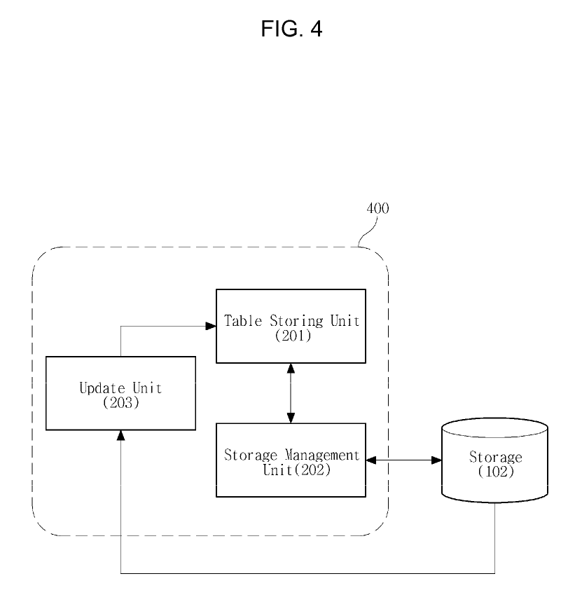

FIG. 4 is a block diagram illustrating an exemplary storage management apparatus 400. Referring to FIG. 4, the storage management apparatus 400 may include a table storing unit 201, a storage management unit 202, and an update unit 203. The table storing unit 201 and the storage management unit 202 are configured as described above with reference to FIG. 2.

The update unit 203 updates the allocation unit table stored in the table storing unit 201 according to an actual size of a file to be written. That is, a system developer or a user may use various types of files, and a file system may observe and analyze a pattern of the types of used files and adjust the allocation according to the file size.

To update the allocation unit table, the pattern of the types of used files is observed and analyzed, and the analysis may be conducted statistically based on the actual size of a file to be written.

For example, the average of the file size may be used for updating the allocation unit table. More specifically, a final file size is estimated at a time of writing the file, and the sizes of actual files are accumulatively stored in the table storing unit 201. Then, the average of the stored sizes is calculated when the file size is updated in the unit of allocation in the allocation unit table.

As another example, the size of an actual file may be compared to a particular threshold. For the above-described case, the calculated average of the sizes may be compared to a predetermined threshold and the unit of allocation of the table is updated according to the comparison result.

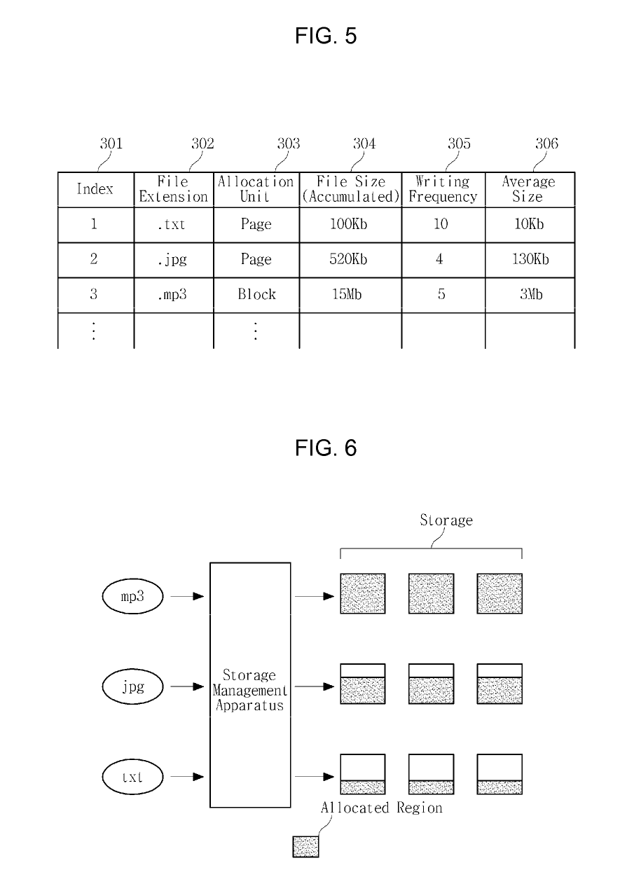

FIG. 5 illustrates another exemplary allocation unit table. Operations of the update unit 203 of FIG. 4 will be described with reference to FIG. 5.

In FIG. 5, a numeral reference 301 denotes index information, 302 denotes file extension information, 303 denotes information of the unit of allocation, 304 denotes the size of actual files (accumulated), 305 denotes the number of times a corresponding file is written, and 306 denotes an average size of files with a corresponding file extension. The update unit 203 calculates the actual size of a written file when the storage management unit 202 allocates a particular portion of the storage 102 and writes the file on the allocated portion. The calculated size of the file is accumulatively stored in the file size column 304. Also, the number of times of writing the file is stored in the number of times column 305. In addition, the file size stored in the column 304 is divided by a value stored in the column 305 to obtain the average size of the corresponding file in column 306.

For example, referring to the first row of the table, a txt file is written ten times and the total size of the file is 100 KB, and thus the average file size is 10 KB. Additionally, referring to the third row of the table, an MP3 file is written three times and the total size of the file is 15 MB, and thus the average file size is 3 MB.

In this example, the update unit 203 may update the allocation unit 303 based on the average size 306. As an example, referring to the second row of the table, initially the allocation unit is set as a page, but it may be changed to a block since the average size of the corresponding file exceeds 128 KB, which is the size of a unit block.

Furthermore, as described above, the allocation unit may be updated based on a predetermined threshold (e.g. 70%). As an example, if the average size of a file does not exceed 128 KB, but rather about 90 KB which is 70 percent of the 128 KB, the allocation unit may be updated such that allocation is performed in units of blocks.

FIG. 6 is a diagram illustrating an example of storage allocation. Referring to FIG. 6, an MP3 file with a comparatively large size is allocated with a portion in units of blocks and written in the same block contiguously, and a jpg file and a txt file are allocated with portions of the storage in units of pages and written therein.

As described above, an approximate size of a file may be estimated based on the file extension information, and the unit of allocation which may cause performance difference of the storage may be set based on the estimated size so that reading, writing and erasing performance and the overall performance of the storage may be improved.

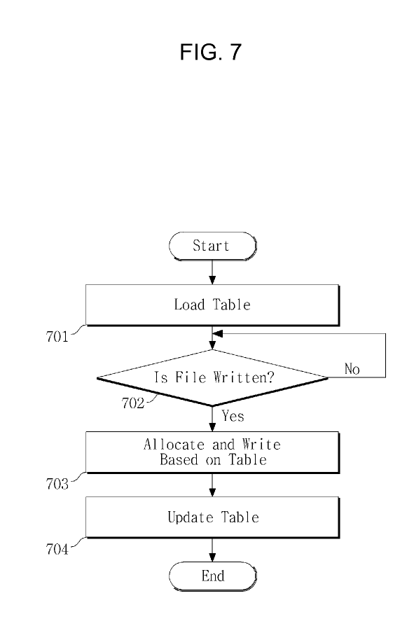

FIG. 7 is a flowchart illustrating an exemplary method of managing storage. This method may be implemented by the computing device or the storage management apparatus, as described above.

In operation 701, an allocation unit table is loaded. In the allocation unit table, the unit of allocation of a storage is specified and the specified allocation unit alters the storage performance according to a file extension of a corresponding file.

Because files with the same file extension generally have similar sizes, the approximate sizes of files may be estimated based upon the file extension information. The allocation unit of the storage is specified according to the estimated file size. For example, if the storage is a NAND flash, a relatively small file may be allocated with a portion of the storage in units of pages and a file with a relatively large file may be allocated with a portion in units of blocks. For another example, if the storage is a hard disk, tracks are allocated with respect to the size of a file.

When there is a file writing command in the storage (operation 702), a corresponding portion of the storage is obtained based on an allocation unit table and the file is written in the obtained storage portion (operation 703).

Then, the allocation unit table is updated with respect to the actual size of the file once the file is written in the storage (operation 704). The allocation unit table may be updated according to an average value of the sizes of the written file a predetermined threshold compared to the size of the file.

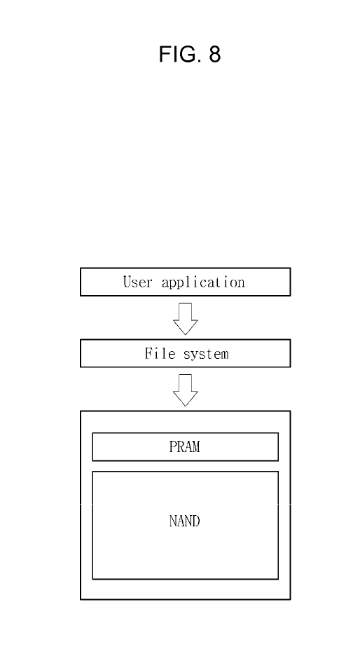

FIG. 8 is a diagram illustrating management of a storage unit when different types of devices such as a phase-change random access memory (PRAM) and NAND flash are included in the storage unit. Referring to FIG. 8, a file may be written on a particular physical location of the storage according to the file extension.

For example, when PRAM and NAND flash are implemented in a complex manner, a file system may designate, for example, 0 to 1000 numbered contiguous sectors as a PRAM and 1001 to 10000 numbered contiguous sectors as a NAND flash. Thus, only the files with particular file extension may be written to the PRAM. The above-described allocation unit table may indicate a physical address as well as the unit of allocation.

The methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. The computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

Flash memory devices and/or memory controllers may be included in various types of packages. For example, the flash memory devices and/or memory controllers may be embodied using packages such as Package on Packages (PoPs), Ball Grid Arrays (BGAs), Chip Scale Packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Quad Flatpack (QFP), Small Outline Integrated Circuit (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

The flash memory devices and/or the memory controllers may constitute memory cards. In this case, the memory controllers may be constructed to communicate with an external device for example, a host using any one of various types of interface protocols such as a Universal Serial Bus (USB), a Multi Media Card (MMC), a Peripheral Component Interconnect-Express (PCI-E), Serial Advanced Technology Attachment (SATA), Parallel ATA (PATA), Small Computer System Interface (SCSI), Enhanced Small Device Interface (ESDI), and Integrated Drive Electronics (IDE).

The flash memory devices may be non-volatile memory devices that can maintain stored data even when power is cut off. According to an increase in the use of mobile devices such as a cellular phone, a personal digital assistant (PDA), a digital camera, a portable game console, and an MP3 player, the flash memory devices may be more widely used as data storage and code storage. The flash memory devices may be used in home applications such as a high definition television (HDTV), a DVD, a router, and a Global Positioning System (GPS).

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A storage management apparatus comprising:
a table storing unit for storing an allocation unit table ; and
a storage management unit for managing the storing of a file in a storage device, according to the allocation unit table,
wherein the allocation unit table includes information of a unit of allocation for storing the file in the storage device, according to a file extension of the file.

2. The storage management apparatus of claim 1, wherein the unit of allocation is selected as at least one from a group consisting of a block, a page, and a track.

3. The storage management apparatus of claim 2, wherein when the storage devices comprises a NAND flash, the unit of allocation is selected as one of a page or a block.

4. The storage management apparatus of claim 2, wherein when the storage device comprises a hard disk drive (HDD), the unit of allocation is selected as a track.

5. The storage management apparatus of claim 3, wherein when the unit of allocation is selected as a block, the storage management unit writes the file in an allocated block substantially continuously.

6. The storage management apparatus of claim 1, further comprising an update unit for updating the allocation unit table according to a size of a written file.

7. The storage management apparatus of claim 6, wherein the update unit updates the allocation unit table according to an average of the size of the written file.

8. The storage management apparatus of claim 6, wherein the update unit compares the size of the written file to a predetermined threshold and updates the allocation unit table.

9. A storage management apparatus comprising:
a storing unit including at least two storage devices;
a table storing unit for storing an allocation unit table; and
a storage management unit for managing the storing of the file in each of the storage devices, according to the allocation unit table,
wherein the allocation unit table includes information of a unit of allocation for storing the file in each of the storage devices, according to a file extension of the file.

10. The storage management apparatus of claim 9, wherein each of the storage devices comprises one selected from the group consisting of a NAND flash, a hard disk, and a phase-change random access memory (PRAM).

11. The storage management apparatus of claim 9, wherein the unit of allocation is selected as at least one from a group consisting of a block, a page, and a track.

12. The storage management apparatus of claim 9, further comprising an update unit for updating the allocation unit table according to a size of a written file.

13. The storage management apparatus of claim 12, wherein the update unit updates the allocation unit table according to an average of the size of the written file.

14. The storage management apparatus of claim 12, wherein the update unit compares the size of the written file to a predetermined threshold and updates the allocation unit table.

15. A computing device for controlling and managing a storage, comprising:
a storing unit for storing a file; and
a storage management unit for allocating a predetermined region of the storing unit for writing a file to the storing unit and for managing the storing unit,
wherein the storage management unit selects a unit of allocation for the storing unit according to a file extension of the file.

16. The computing device of claim 15, wherein when the storing unit comprises a NAND flash, the unit of allocation is selected as one of a page or a block.

17. The computing device of claim 15, wherein when the storing unit comprises a hard disk drive (HDD), the unit of allocation is selected as a track.

18. The computing device of claim 16, wherein when the unit of allocation is selected as a block, the storage management unit writes the file in an allocated block substantially continuously.

19. A storage management method comprising:
loading an allocation unit table which specifies a physical location of a storage according to a file extension of the file; and
allocating a storage based on the allocation unit table,
wherein the allocation unit table includes information of the physical location according to a file extension.

20. The storage management method of claim 19, further comprising updating the allocation unit table according to a size of a file.

21. A computer-readable recording medium having embodied thereon a computer program for executing a storage management method comprising:
loading an allocation unit table; and
allocating a storage based on the allocation unit table,
wherein the allocation unit table includes information of a unit of allocation for storing according to a file extension.

22. The computer-readable recording medium of claim 21, wherein when the storage comprises a NAND flash, the unit of allocation is selected as one of a page or a block.

23. The computer-readable recording medium of claim 21, wherein when the storage comprises a hard disk drive (HDD), the unit of allocation is selected as a track.
